(19) United States
(12) Patent Application Publication
(10) Pub. No.: US 2019/0174777 A1
(43) Pub. Date: Jun. 13, 2019

(54) FORTUNE COOKIE AND METHOD OF MAKING THE SAME

(71) Applicant: Joseph Schmuck, Arlington, TX (US)

(72) Inventor: Joseph Schmuck, Arlington, TX (US)

(21) Appl. No.: 16/214,064

(22) Filed: Dec. 8, 2018

Related U.S. Application Data
(60) Provisional application No. 62/596,436, filed on Dec. 8, 2017.

(51) Int. Cl. A21D 13/48; A21B 5/02; A21C 15/02

(52) U.S. Cl. CPC A21D 13/48; A21C 15/02; A21B 5/02

(57) ABSTRACT

A fortune cookie includes a body composed of an edible cookie batter and the body being spherical in shape and having an internal pocket contained therein; an image displayed on an exterior surface of the body; and a piece of paper disposed within the internal pocket, the piece of paper having a fortune written thereon; the piece of paper is removable from the internal cavity via breaking the body.

### BACKGROUND

### 1. Field of the Invention

The present invention relates generally to fortune cookies, and more specifically, to a spherical fortune cookie with an image displayed on the fortune cookie.

### 2. Description of Related Art

Fortune cookies are well known in the art and are effective means to provide enjoyment and surprise to the experience of eating a cookie. For example, FIGS. 1A and 1B depict a conventional fortune cookie 101 having a cookie body 103 with a fortune 105 secured therein. During use, the user breaks open cookie body 103 to retrieve and read the fortune.

One of the problems commonly associated with cookie 101 is the unintriguing aesthetical appearance. For example, when a person is provided with a selection of fortune cookies, they all appear the same, thereby making the selection arbitrary and unexciting.

Accordingly, although great strides have been made in the area of fortune cookies, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are oblique views of a common fortune cookie;

FIG. 2 is a front view of a fortune cookie in accordance with a preferred embodiment of the present application;

FIGS. 3A and 3B are back views of the fortune cookie of FIG. 2; and

FIG. 4 is a flowchart of the method of making the fortune cookie of FIG. 2.

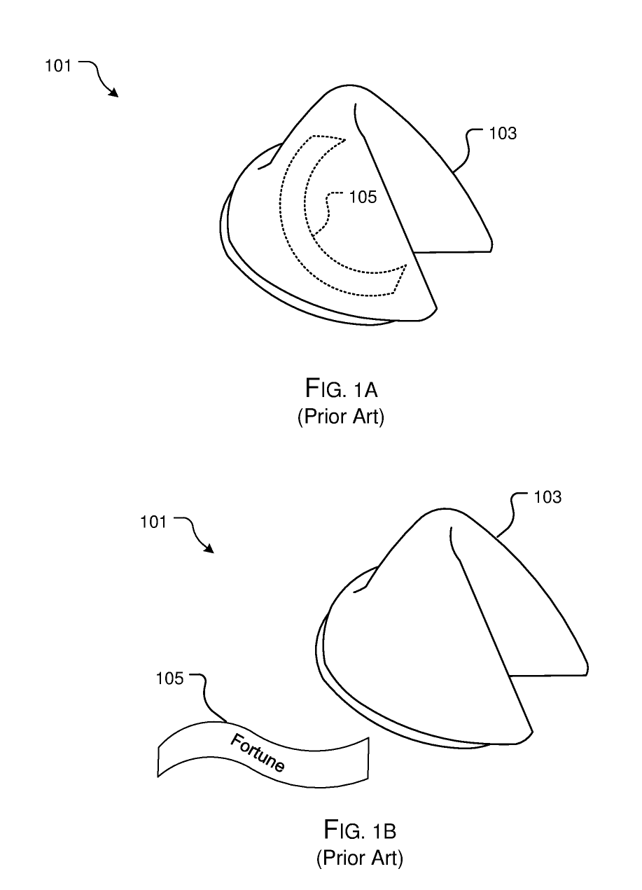

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional fortune cookies. Specifically, the present invention provides a more aesthetically pleasing fortune cookie. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

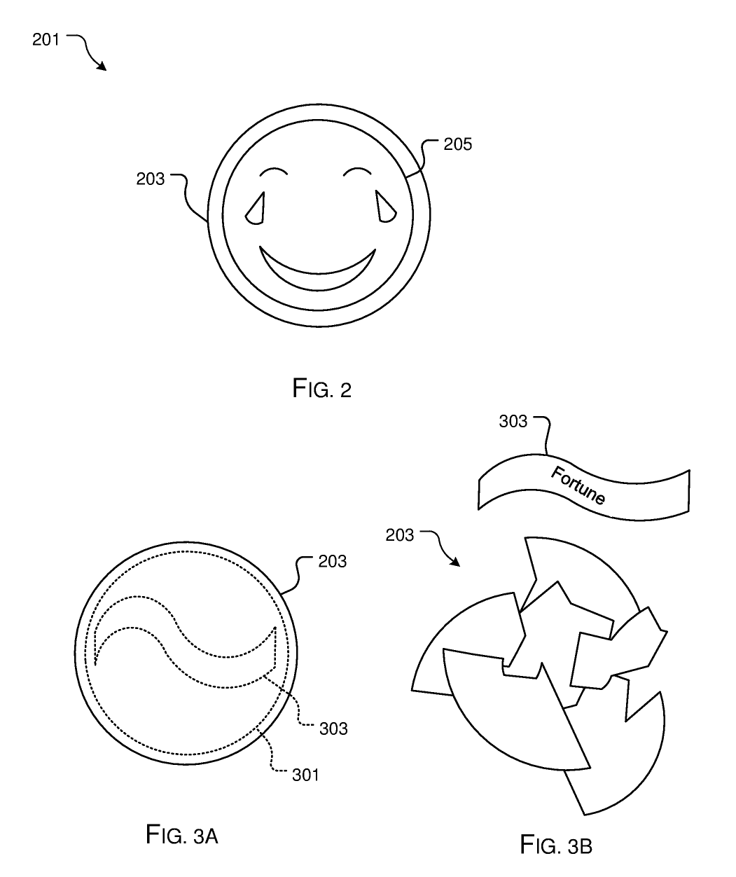

Referring now to the drawings wherein like reference characters identify corresponding or similar elements throughout the several views, FIG. 2 depicts a front view of a fortune cookie 201 in accordance with a preferred embodiment of the present application. It will be appreciated that cookie 201 overcomes one or more of the above-listed problems commonly associated with conventional fortune cookies.

In the contemplated embodiment, cookie 201 includes a spherical body 203 having an image 205 displayed on an exterior surface of the body. It is contemplated that image 205 can be printed onto the exterior, such as with edible paints, dyes, stamps, or the like, or alternatively, the image can be imprinted into the surface via one or more molding devices. In the preferred embodiment, image 205 represents a facial image, such as a smiley face, sad face, crying face, laughing face, or any of facial expression. It should be appreciated, that such images can represent common emoji's, thereby being recognizable to the user.

It should be appreciated that one of the unique features believed characteristic of the present application is the spherical shape with the image displayed on the exterior surface. It should be appreciated that this feature provides for an improved consumer reaction and appeal.

In FIGS. 3A and 3B, back views of cookie 201 are shown. In the preferred embodiment, body 203 includes an internal pocket 301 with a piece of paper 303 having a fortune written thereon. Upon breaking body 203, the paper 303 is removed by the consumer. In one contemplated embodiment, the fortune is specifically correlated to the image 205 in some form or fashion, thereby allowing for the consumer to select a desired image for the fortune.

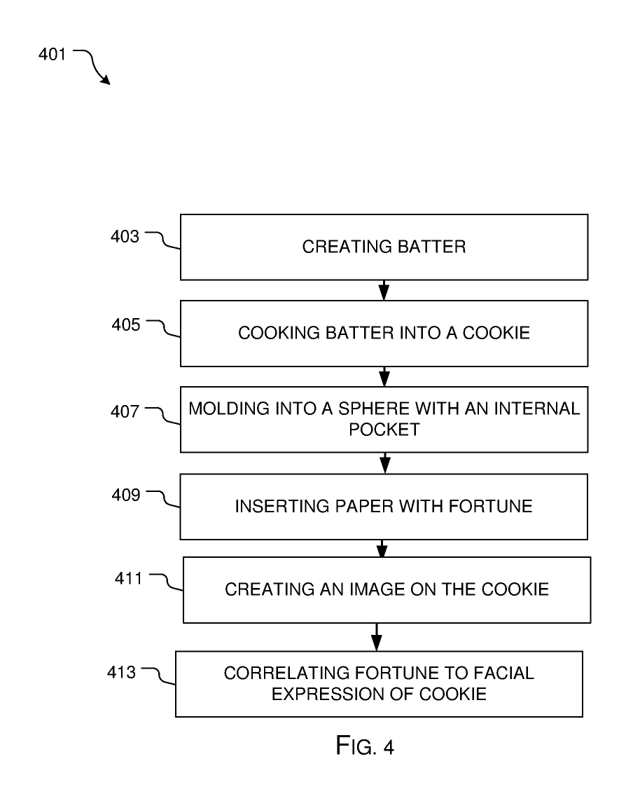

In FIG. 4, a method of making cookie 201 is shown. A batter is created for the cookie and baked into a cookie, as shown with boxes 403, 405. Before the cookie cools, the cookie is molded into a spherical shape and the paper is placed inside, as shown with boxes 407, 409. An image is displayed on an exterior surface of the spherical cookie, as shown with box 411. It should be appreciated that the image can be printed, painted, stamped, or the like, or alternatively, the image can be embedded via one or more molds. In some embodiments, the image is correlated to the fortune printed on the paper, as shown with box 413.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A fortune cookie, comprising:
a body composed of an edible cookie batter and the body being spherical in shape and having an internal pocket contained therein;
an image displayed on an exterior surface of the body; and
a piece of paper disposed within the internal pocket, the piece of paper having:
a fortune written thereon;
wherein the piece of paper is removable from the internal pocket via breaking the body.

2. The fortune cookie of claim 1, wherein the image is a facial expression.

3. The fortune cookie of claim 1, wherein the image correlates to the fortune written on the piece of paper.

4. A method of making a fortune cookie, the method comprising:
creating a batter;
cooking the batter to create a cookie;
molding the batter into a spherical cookie while simultaneously inserting a piece of paper with a fortune printed thereon into a pocket creating during molding of the cookie; and
creating an image on the exterior surface of the fortune cookie.

5. The method of claim 4, wherein the image is printed onto the exterior surface.

6. The method of claim 4, wherein the image is imprinted into the exterior surface via a mold.

7. The method of claim 4, wherein the image is a facial expression.

8. The method of claim 7, further comprising:
correlating the facial expression to the fortune printed on the piece of paper.
